(19) United States
(12) Patent Application Publication
(10) Pub. No.: US 2019/0065906 A1
(43) Pub. Date: Feb. 28, 2019

(54) METHOD AND APPARATUS FOR BUILDING HUMAN FACE RECOGNITION MODEL, DEVICE AND COMPUTER STORAGE MEDIUM

(71) Applicant: BAIDU ONLINE NETWORK TECHNOLOGY (BEIJING) CO., LTD, Haidian District Beijing (CN)

(72) Inventors: Renliang WENG, Haidian District Beijing (CN); Tao HE, Haidian District Beijing (CN); Gang ZHANG, Haidian District Beijing (CN); Jingtuo LIU, Haidian District Beijing (CN); Wenxian LIU, Haidian District Beijing (CN)

(73) Assignee: BAIDU ONLINE NETWORK TECHNOLOGY (BEIJING) CO., LTD ., Haidian District Beijing (CN)

(21) Appl. No.: 16/113,240

(22) Filed: Aug. 27, 2018

(30) Foreign Application Priority Data
Aug. 25, 2017 (CN) 2017107442779

(51) Int. Cl. G06K 9/62; G06K 9/00

(52) U.S. Cl. CPC G06K 9/6262; G06K 9/00288

(57) ABSTRACT

The present disclosure provides a method and apparatus for building a human face recognition model, a device and a computer storage medium, wherein the method comprises: regarding a known user's face images annotated with ages as training samples; using the training samples to train a deep neural network to obtain a human face recognition model, the human face recognition model being used to perform user identification for input face images. The present disclosure can solve the problem about reduction of the face recognition rate caused by age changes, and improve robustness of face recognition for ages.

The present application claims the priority of Chinese Patent Application No. 201710744277.9, filed on Aug. 25, 2017, with the title of “Method and apparatus for building human face recognition model, device and computer storage medium”. The disclosure of the above applications is incorporated herein by reference in its entirety.

### FIELD OF DISCLOSURE

The present disclosure relates to the technical field of computer application, and particularly to a method and apparatus for building a human face recognition model, a device and a computer storage medium.

### BACKGROUND OF THE DISCLOSURE

Human face recognition is a biological recognition technology of performing identity recognition based on human facial feature information. Human face recognition products are already widely applied to fields such as finance, judicature, troops, public security, frontier inspection, government, aerospace, electric power, factories, education, medical care and many enterprises sand institutions. As the technology further gets mature and a social recognition degree improves, human face recognition technology will be applied to more fields.

However, since people's age changes cause changes of human faces, the problem about reduction of a human face recognition rate caused by age changes becomes a challenging problem in the field of human face recognition.

### SUMMARY OF THE DISCLOSURE

In view of the above, the present disclosure provides a method and apparatus for building a human face recognition model, a device and a computer storage medium, to solve a problem about reduction of the face recognition rate caused by age changes.

Specific technical solutions are as follows:

The present disclosure further provides a method of building a human face recognition model, the method comprising:
regarding a known user's face images annotated with ages as training samples;
using the training samples to train a deep neural network to obtain a human face recognition model, the human face recognition model being used to perform user identification for input face images.

According to a preferred implementation mode of the present disclosure, the deep neural network comprises: a convolutional neural network or a residual convolutional neural network.

According to a preferred implementation mode of the present disclosure, a training target upon training the deep neural network is:
to minimize similarity between face images of different persons, and the similarity between face images of the same person at different ages is negatively correlated to an age difference.

According to a preferred implementation mode of the present disclosure, the using the training samples to train a deep neural network to obtain a human face recognition model comprises:
using the deep neural network to learn the training samples to obtain face features of respective training samples;
using face features of the respective training samples to determine a recognition loss, and using the recognition loss to perform parameter adjustment for the deep neural network to minimize the recognition loss;
wherein the recognition loss is determined by similarity between face images of different persons and similarity of face images of the same person at different ages.

The present disclosure further provides an apparatus for building a human face recognition model, the apparatus comprising:
a sample obtaining unit configured to regard a known user's face images annotated with ages as training samples;
a model training unit configured to use the training samples to train a deep neural network to obtain a human face recognition model, the human face recognition model being used to perform user identification for input face images.

According to a preferred implementation mode of the present disclosure, the deep neural network comprises: a convolutional neural network or a residual convolutional neural network.

According to a preferred implementation mode of the present disclosure, a training target employed by the model training unit upon training the deep neural network is:
to minimize similarity between face images of different persons, and the similarity between face images of the same person at different ages is negatively correlated to an age difference.

According to a preferred implementation mode of the present disclosure, the model training unit specifically performs:
using the deep neural network to learn the training samples to obtain face features of respective training samples;
using face features of the respective training samples to determine a recognition loss, and using the recognition loss to perform parameter adjustment for the deep neural network to minimize the recognition loss;
wherein the recognition loss is determined by similarity between face images of different persons and similarity of face images of the same person at different ages.

The present disclosure further provides a device, the device comprising:
one or more processors;
a storage for storing one or more programs,
the one or more programs, when executed by said one or more processors, enable said one or more processors to implement the above-mentioned method.

The present disclosure further provides a storage medium containing computer executable instructions, wherein the computer executable instructions, when executed by a computer processor, implement the above-mentioned method.

As can be seen from the above technical solutions, the human face recognition model built in the present disclosure can learn feature vectors more sensitive for ages very well, and therefore can have a higher robustness for ages upon human face recognition, and solve the problem about reduction of the face recognition rate caused by age changes.

### BRIEF DESCRIPTION OF DRAWINGS

FIG. 1 is a flow chart of a method of building a human face recognition model according to an embodiment of the present disclosure;

FIG. 2 is a structural schematic diagram of a human face recognition model according to an embodiment of the present disclosure;

FIG. 3 is a structural schematic diagram of a ResNET type CNN according to an embodiment of the present disclosure;

FIG. 4 is a structural schematic diagram of an apparatus of building a human face recognition model according to an embodiment of the present disclosure;

FIG. 5 illustrates a block diagram of an example computer system/server 012 adapted to implement an implementation mode of the present disclosure.

### DETAILED DESCRIPTION OF PREFERRED EMBODIMENTS

The present disclosure will be described in detail in conjunction with figures and specific embodiments to make objectives, technical solutions and advantages of the present disclosure more apparent.

A core ideal of the present disclosure lies in training according to large-scale cross-age human face image data to obtain a human face recognition model which is robust for age information. The method according to the present disclosure will be described in detail in conjunction with embodiments.

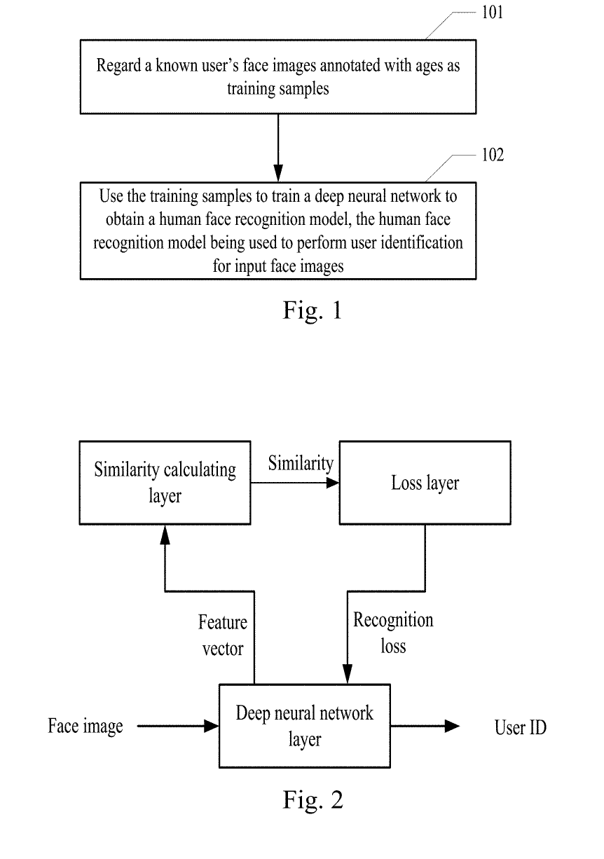

FIG. 1 is a flow chart of a method of building a human face recognition model according to an embodiment of the present disclosure. As shown in FIG. 1, the method may comprise the following steps:

In 101, a known user's face images annotated with ages are regarded as training samples.

In the embodiment of the present disclosure, a known user's face images at different ages are collected, and respectively annotated with corresponding ages. Since usually at preschool and after adult, face feature changes are more sensitive to ages, it is possible to collect face images of a plurality of ages before schooling, for example, face images at the age of 1, 2 and 3, and collect face images of a plurality of ages after adult, for example, face images at the age of 18, 25, 35, 45 and so on. Granularity of ages may be set according to needs, for example, age 1 may be regarded as the granularity of ages, or age 5 may be regarded as the granularity of ages.

In the training data obtained in this way, face images are already annotated with user IDs and ages.

In 102, the training samples are used to train a deep neural network to obtain a human face recognition model, the human face recognition model being used to perform user identification for input face images.

The structure of the human face recognition model is described to facilitate the understanding of the human face recognition model according to the embodiment of the present disclosure. As shown in FIG. 2, the human face recognition model may comprise a deep neural network layer, a similarity calculating layer, and a loss layer.

The deep neural network layer in the present embodiment may comprise a deep neural network and a full connection layer, wherein the employed deep neural network may be a CNN (Convolutional Neural Network), a ResNET (Residual Net) type CNN, and so on. Although the deep neural network has a very good learning capability, it is harder to train. The accuracy slides down in the case of a certain depth. To solve this problem, the present disclosure may be used based on CNN, but not limited to the ResNET type CNN.

First, the ResNET type CNN is described.

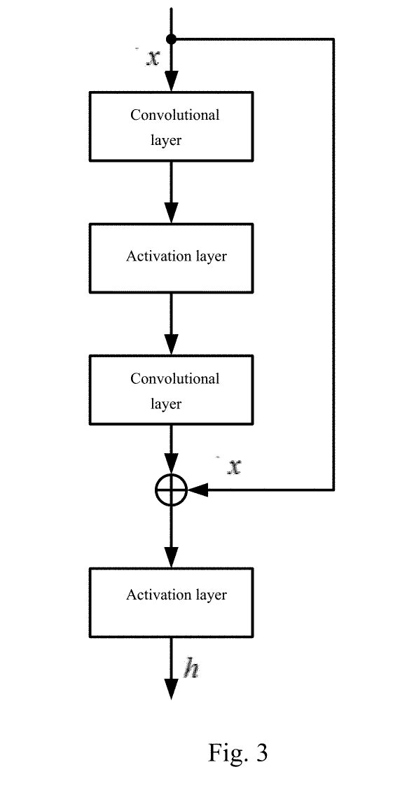

The ResNet may be used to simplify the training of CNN. The ResNet comprises several ResBlocks (stack residual blocks) which each comprise a direct connection between low-layer output and high-layer input. As shown in FIG. 3, each ResBlock may be defined as:

h=F(x,Wᵢ)+x
where x and h respectively represent input and output of the ResBlock, and F represents a mapping function of a nonlinear layer of stacks.

As shown in FIG. 3, ResBlock may comprise two convolutional layers and two activation layers. Each ResBlock comprises the same structure, and a jump connection is the same mapping for ^{x}. If the number of channels increases, a convolutional layer may be used.

The deep neural network layer is responsible for extracting feature vectors from input face images. Assuming that what is input is a face image of the user identified as i at an age identified as n, the feature vector extracted with respect to the face image is represented as Pᵢ(n).

The deep neural network layer extracts feature vectors with respect to face images, and maps the extracted feature vectors to the user ID through the full connection layer in the deep neural network layer, thereby completing the function of human face recognition. The feature vectors extracted by the deep neural network are input in the similarity calculating layer. The similarity calculating layer is used to calculate similarity between any two face images. The similarity is reflected by a similarity between feature vectors corresponding to face images. Assuming the similarity between the face image of the user identified as i at an age identified as n and the face image of the user identified as j at an age identified as m may be represented as: S(Pᵢ(n),Pⱼ(m)).

After the similarity calculating layer, a similarity calculation result is output to the loss layer. The mapping layer is responsible for calculating a recognition loss, and feeding back the calculated recognition loss to the deep neural network layer to perform parameter adjustment for the deep neural network layer to minimize the recognition loss.

A target of training the deep neural network is to minimize the similarity between face images of different persons, and furthermore, the similarity between face images of the same person at different ages is negatively correlated to an age difference. It is expressed with the following formula:

min{S(Pᵢ(n),Pⱼ(m))} wherein i≠j.

S(Pₖ(n1), Pₖ(m1))>S(Pₖ(n2), Pₖ(m2)), wherein |n1−m1|<|n2−m2|.

Take an example. As for different users, regardless ages, the similarity of face images between different users is minimized. As for the same user, the similarity between the user's face images at age 2 and age 3 is larger than the similarity between the user's face images at age 1 and age 3; the similarity between the user's face images at age 28 and age 58 is smaller than the similarity between the user's face images at age 38 and age 48.

The recognition loss may be expressed with the following equation:

$$Loss = {\sum }_{i , j , k , n , m} ( S ( {P}_{i} ( n ) , {P}_{j} ( m ) ) - S ( {P}_{k} ( n ) , {P}_{k} ( m ) ) ) - λ {\sum }_{k , n 1 , m 1 , n 2 , m 2} ( S ( {P}_{k} ( n 1 ) , {P}_{k} ( m 1 ) ) - S ( {P}_{k} ( n 2 ) , {P}_{k} ( m 2 ) ) )$$

where λ is a preset coefficient and may take an experiment value or an empirical value.

Certainly, the above equation expression is only an illustrative example. The recognition loss may also employ other equation expressions which all fall within the extent of protection of the present disclosure so long as they are with the principle of the above training target.

It can be seen from the above training process that the human face recognition model obtained after the above training learns feature vectors more sensitive for ages very well, and therefore has a higher robustness for ages upon human face recognition.

When the duly-built human face recognition model is used for face recognition, a to-be-recognized face image is input into the human face recognition model, and the human face recognition model can extract a feature vector from the face image, and maps the feature vector to a corresponding user ID.

The above describes the method according to the present disclosure in detail. The apparatus according to the present disclosure will be described in detail in conjunction with an embodiment.

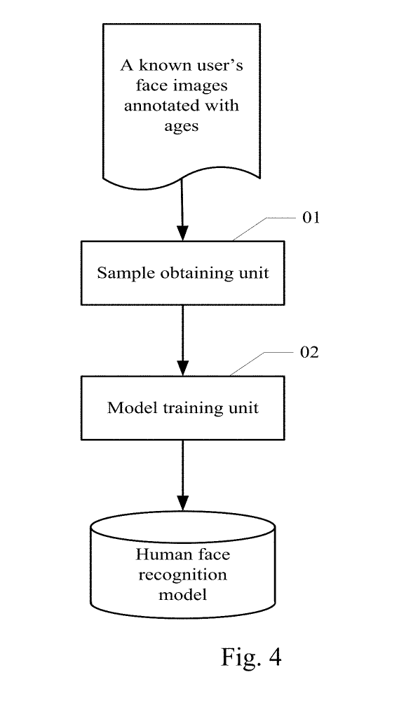

FIG. 4 is a structural schematic diagram of an apparatus of building a human face recognition model according to an embodiment of the present disclosure. As shown in FIG. 4, the apparatus comprises: a sample obtaining unit 01 and a model training unit 02.

The sample obtaining unit 01 is responsible for regarding a known user's face images annotated with ages as training samples.

In the embodiment of the present disclosure, a known user's face images at different ages are collected, and respectively annotated with corresponding ages. It is possible to collect face images of a plurality of ages before schooling, for example, face images at the age of 1, 2 and 3, and collect face images of a plurality of ages after adult, for example, face images at the age of 18, 25, 35, 45 and so on. Granularity of ages may be set according to needs, for example, age 1 may be regarded as the granularity of ages, or age 5 may be regarded as the granularity of ages.

In the training data obtained in this way, face images are already annotated with user IDs and ages.

The model training unit 02 is responsible for using the training samples to train a deep neural network to obtain a human face recognition model, the human face recognition model being used to perform user identification for input face images.

The human face recognition model may comprise a deep neural network layer, a similarity calculating layer, and a loss layer.

The deep neural network layer in the present embodiment may comprise a deep neural network and a full connection layer, wherein the employed deep neural network may be a CNN (Convolutional Neural Network), a ResNET (Residual Net) type CNN, and so on. Although the deep neural network has a very good learning capability, it is harder to train. The accuracy slides down in the case of a certain depth. To solve this problem, the present disclosure may be used based on CNN, but not limited to the ResNET type CNN.

The deep neural network layer extracts feature vectors with respect to face images, and maps the extracted feature vectors to the user ID through the full connection layer in the deep neural network layer, thereby completing the function of human face recognition. The feature vectors extracted by the deep neural network are input in the similarity calculating layer. The similarity calculating layer is used to calculate similarity between any two face images. The similarity is reflected by a similarity between feature vectors corresponding to face images. Assuming the similarity between the face image of the user identified as i at an age identified as n and the face image of the user identified as j at an age identified as m may be represented as: S(Pᵢ(n),Pⱼ(m)).

After the similarity calculating layer, a similarity calculation result is output to the loss layer. The mapping layer is responsible for calculating a recognition loss, and feeding back the calculated recognition loss to the deep neural network layer to perform parameter adjustment for the deep neural network layer to minimize the recognition loss.

A target of training the deep neural network is to minimize the similarity between face images of different persons, and furthermore, the similarity between face images of the same person at different ages is negatively correlated to an age difference.

After the apparatus shown in FIG. 4 is used to build the human face recognition model, the human face recognition model may be used to perform face recognition. Specifically, a to-be-recognized face image is input into the human face recognition model, and the human face recognition model can extract a feature vector from the to-be-recognized face image, the feature vector is highly sensitive for ages, and the feature vector is mapped to a corresponding user ID, thereby completing face recognition.

An application scenario in which the present disclosure may be used is listed here:

Many missing children get lost at a very small age. After they grow to a certain age, they are difficult to recognize even by their parents by blood. The human face recognition model built in the manner according to the present disclosure can be used to perform cross-age face recognition with ah very high accuracy.

On the one hand, the present disclosure can provide assistance in a phase of clearing up a case of a missing kid, and on the other hand can provide a basis for seeking for parents after the missing kid is found.

Take an example. Parents or relatives of a missing kid upload the missing kid's photo to a system and register. The system relies on a lot of cameras in real environment to capture face images of passing people, and then performs face recognition for these face images to determine whether a kid is the missing kid. Even if the kid grows up later and facial appearance changes, he can still be recognized with higher recognition accuracy. In this way, the present disclosure may provide assistance for a public security system to clear up a case.

Take another example. After the public security system finds the missing kid, the kid's face image may be fed into the human face recognition model obtained from the present disclosure for face recognition, thereby determining whether the kid is the already-registered missing kid. If the kid is the already-registered missing kid, the kid's parents or relatives registering the kid can be found on this basis.

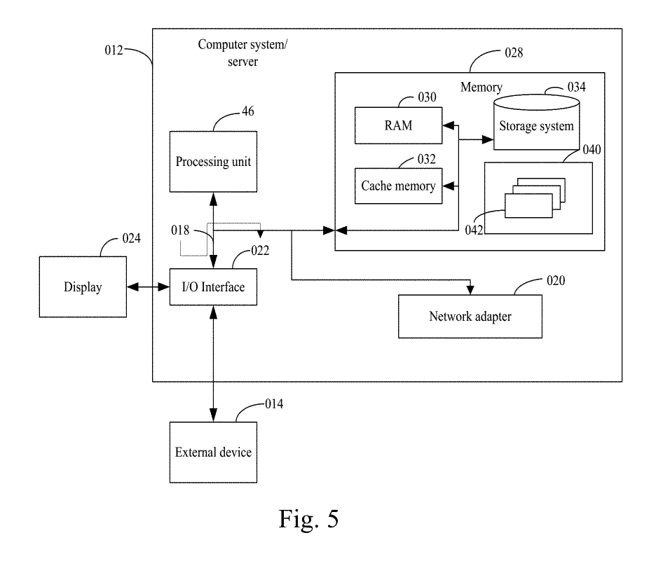

FIG. 5 illustrates a block diagram of an example computer system/server 012 adapted to implement an implementation mode of the present disclosure. The computer system/server 012 shown in FIG. 5 is only an example and should not bring about any limitation to the function and scope of use of the embodiments of the present disclosure.

As shown in FIG. 5, the computer system/server 012 is shown in the form of a general-purpose computing device. The components of computer system/server 012 may include, but are not limited to, one or more processors (processing units) 016, a system memory 028, and a bus 018 that couples various system components including system memory 028 and the processor 016.

Bus 018 represents one or more of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 012 typically includes a variety of computer system readable media. Such media may be any available media that is accessible by computer system/server 012, and it includes both volatile and non-volatile media, removable and non-removable media.

The system memory 028 can include computer system readable media in the form of volatile memory, such as random access memory (RAM) 030 and/or cache memory 032. Computer system/server 012 may further include other removable/non-removable, volatile/non-volatile computer system storage media. By way of example only, storage system 034 can be provided for reading from and writing to a non-removable, non-volatile magnetic media (not shown in FIG. 5 and typically called a “hard drive”). Although not shown in FIG. 5, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each drive can be connected to bus 018 by one or more data media interfaces. The memory 028 may include at least one program product having a set (e.g., at least one) of program modules that are configured to carry out the functions of embodiments of the present disclosure.

Program/utility 040, having a set (at least one) of program modules 042, may be stored in the system memory 028 by way of example, and not limitation, as well as an operating system, one or more disclosure programs, other program modules, and program data. Each of these examples or a certain combination thereof might include an implementation of a networking environment. Program modules 042 generally carry out the functions and/or methodologies of embodiments of the present disclosure.

Computer system/server 012 may also communicate with one or more external devices 014 such as a keyboard, a pointing device, a display 024, etc. In the present disclosure, the computer system/server 012 communicates with an external radar device, or with one or more devices that enable a user to interact with computer system/server 012; and/or with any devices (e.g., network card, modem, etc.) that enable computer system/server 012 to communicate with one or more other computing devices. Such communication can occur via Input/Output (I/O) interfaces 022. Still yet, computer system/server 012 can communicate with one or more networks such as a local area network (LAN), a general wide area network (WAN), and/or a public network (e.g., the Internet) via a network adapter 020. As depicted in the figure, network adapter 020 communicates with the other communication modules of computer system/server 012 via the bus 018. It should be understood that although not shown in FIG. 5, other hardware and/or software modules could be used in conjunction with computer system/server 012. Examples, include, but are not limited to: microcode, device drivers, redundant processing units, external disk drive arrays, RAID systems, tape drives, and data archival storage systems, etc.

The processing unit 016 executes various function applications and data processing by running programs stored in the system memory 028, for example, implements the method in embodiments of the present disclosure.

The above-mentioned computer program may be disposed in a computer storage medium, i.e., the computer storage medium is encoded with a computer program. When the program, executed by one or more computers, enables said one or more computers to execute steps of methods and/or operations of apparatuses as shown in the above embodiments of the present disclosure. For example, the method stated in the embodiments of the present disclosure is executed by said one or more processors.

As time goes by and technologies develop, the meaning of medium is increasingly broad. A propagation channel of the computer program is no longer limited to tangible medium, and it may also be directly downloaded from the network. The computer-readable medium of the present embodiment may employ any combinations of one or more computer-readable media. The machine readable medium may be a computer readable signal medium or a computer readable storage medium. A computer readable medium for example may include, but not limited to, an electronic, magnetic, optical, electromagnetic, infrared, or semiconductor system, apparatus, or device, or any suitable combination of the foregoing. More specific examples (non-exhaustive listing) of the computer readable storage medium would include an electrical connection having one or more conductor wires, a portable computer magnetic disk, a hard disk, a random access memory (RAM), a read-only memory (ROM), an erasable programmable read-only memory (EPROM or Flash memory), optical fiber, a portable compact disc read-only memory (CD-ROM), an optical storage device, a magnetic storage device, or any suitable combination of the foregoing. In the text herein, the computer readable storage medium can be any tangible medium that includes or stores a program. The program may be used by an instruction execution system, apparatus or device or used in conjunction therewith.

The computer-readable signal medium may be included in a baseband or serve as a data signal propagated by part of a carrier, and it carries a computer-readable program code therein. Such propagated data signal may take many forms, including, but not limited to, electromagnetic signal, optical signal or any suitable combinations thereof. The computer-readable signal medium may further be any computer-readable medium besides the computer-readable storage medium, and the computer-readable medium may send, propagate or transmit a program for use by an instruction execution system, apparatus or device or a combination thereof.

The program codes included by the computer-readable medium may be transmitted with any suitable medium, including, but not limited to radio, electric wire, optical cable, RF or the like, or any suitable combination thereof.

Computer program code for carrying out operations disclosed herein may be written in one or more programming languages or any combination thereof. These programming languages include an object oriented programming language such as Java, Smalltalk, C++ or the like, and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

What are stated above are only preferred embodiments of the present disclosure and not intended to limit the present disclosure. Any modifications, equivalent substitutions and improvements made within the spirit and principle of the present disclosure all should be included in the extent of protection of the present disclosure.

What is claimed is:

1. A method of building a human face recognition model, wherein the method comprises:
regarding a known user's face images annotated with ages as training samples;
using the training samples to train a deep neural network to obtain a human face recognition model, the human face recognition model being used to perform user identification for input face images.

2. The method according to claim 1, wherein the deep neural network comprises: a convolutional neural network or a residual convolutional neural network.

3. The method according to claim 1, wherein a training target upon training the deep neural network is:
to minimize similarity between face images of different persons, and the similarity between face images of the same person at different ages is negatively correlated to an age difference.

4. The method according to claim 3, wherein the using the training samples to train a deep neural network to obtain a human face recognition model comprises:
using the deep neural network to learn the training samples to obtain face features of respective training samples;
using face features of the respective training samples to determine a recognition loss, and using the recognition loss to perform parameter adjustment for the deep neural network to minimize the recognition loss;
wherein the recognition loss is determined by similarity between face images of different persons and similarity of face images of the same person at different ages.

5. A device, wherein the device comprises:
one or more processors,
a storage for storing one or more programs,
the one or more programs, when executed by said one or more processors, enable said one or more processors to implement a method of building a human face recognition model, wherein the method comprises:
regarding a known user's face images annotated with ages as training samples;
using the training samples to train a deep neural network to obtain a human face recognition model, the human face recognition model being used to perform user identification for input face images.

6. The device according to claim 5, wherein the deep neural network comprises: a convolutional neural network or a residual convolutional neural network.

7. The device according to claim 5, wherein a training target upon training the deep neural network is:
to minimize similarity between face images of different persons, and the similarity between face images of the same person at different ages is negatively correlated to an age difference.

8. The device according to claim 7, wherein the using the training samples to train a deep neural network to obtain a human face recognition model comprises:
using the deep neural network to learn the training samples to obtain face features of respective training samples;
using face features of the respective training samples to determine a recognition loss, and using the recognition loss to perform parameter adjustment for the deep neural network to minimize the recognition loss;
wherein the recognition loss is determined by similarity between face images of different persons and similarity of face images of the same person at different ages.

9. A storage medium containing computer executable instructions, wherein the computer executable instructions, when executed by a computer processor, implement a method of building a human face recognition model, wherein the method comprises:
regarding a known user's face images annotated with ages as training samples;
using the training samples to train a deep neural network to obtain a human face recognition model, the human face recognition model being used to perform user identification for input face images.

10. The storage medium according to claim 9, wherein the deep neural network comprises: a convolutional neural network or a residual convolutional neural network.

11. The storage medium according to claim 9, wherein a training target upon training the deep neural network is:
to minimize similarity between face images of different persons, and the similarity between face images of the same person at different ages is negatively correlated to an age difference.

12. The storage medium according to claim 11, wherein the using the training samples to train a deep neural network to obtain a human face recognition model comprises:
using the deep neural network to learn the training samples to obtain face features of respective training samples;
using face features of the respective training samples to determine a recognition loss, and using the recognition loss to perform parameter adjustment for the deep neural network to minimize the recognition loss;
wherein the recognition loss is determined by similarity between face images of different persons and similarity of face images of the same person at different ages.
